(19) United States
(12) Patent Application Publication
(10) Pub. No.: US 2020/0114802 A1
(43) Pub. Date: Apr. 16, 2020

(54) RECONFIGURABLE VEHICLE CUSTOMIZATION SYSTEM

(71) Applicant: Sharky Laguana, San Francisco, CA (US)

(72) Inventor: Sharky Laguana, San Francisco, CA (US)

(21) Appl. No.: 16/597,546

(22) Filed: Oct. 9, 2019

Related U.S. Application Data
(60) Provisional application No. 62/744,040, filed on Oct. 10, 2018.

(51) Int. Cl. B60P 3/39; B62D 25/02; B62D 27/06; B60N 3/00; B60N 3/16

(52) U.S. Cl. CPC B60P 3/39; B62D 25/02; B60N 3/16; B60N 3/008; B62D 27/06

(57) ABSTRACT

A reconfigurable vehicle customization system including a frame and at least one modular component. The frame includes a plurality of side members configured to be fixedly coupled to an interior of a motor vehicle using existing attachment points of the motor vehicle and without irreparable modification of the motor vehicle, where each side member of the plurality of side members includes at least one track for receiving a modular component. The at least one modular component is removably couplable to the at least one track of the plurality of side members.

### RELATED APPLICATION

This application claims priority to and the benefit of then co-pending U.S. Patent Provisional Patent Application 62/744,040, filed on Oct. 10, 2018, entitled “A RECONFIGURABLE VEHICLE CUSTOMIZATION SYSTEM,” by Sharky Laguana, having Attorney Docket No. CAMP-001.PR, and assigned to the assignee of the present application, which is incorporated herein by reference in its entirety.

### BACKGROUND

Automotive travel encompasses an increasingly large component of the travel and vacation industry. For many, automotive travel allows for a freedom to explore locales not otherwise available, while providing the freedom to schedule travel however the traveler sees fit. Recreational vehicles and campers can further enhance automotive travel by providing lodging, cooking and food storage equipment, and other travel enhancements.

However, recreational vehicles and campers also suffer from drawbacks. For instance, they are expensive, often prohibitively, requiring rental for many vacationers. Furthermore, recreational vehicles and campers can be very difficult to drive and operate without significant experience, which encompasses much of the rental market. Also, particularly for rentals, recreational vehicles and campers typically are available preconfigured and are not customizable by the renter. In particular, it is often cost prohibitive for rental companies to provide such customization, as the time required for vehicle customization is high due to the labor-intensive nature, and the potential financial gain is limited.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 illustrates a perspective view of a reconfigurable vehicle customization system, in accordance with various embodiments.

FIG. 2 illustrates a perspective view of frame of a reconfigurable vehicle customization system, in accordance with various embodiments.

FIG. 3 illustrates an elevation view of frame of a reconfigurable vehicle customization system, in accordance with various embodiments.

FIGS. 4A and 4B illustrate examples of a food preparation and storage module, in accordance with various embodiments.

FIG. 5 illustrates an example of a fan module, in accordance with various embodiments.

FIG. 6 illustrates a perspective view of frame of a reconfigurable vehicle customization system, in accordance with other embodiments.

FIG. 7 illustrates an inner perspective view of frame of a reconfigurable vehicle customization system, in accordance with other embodiments.

FIG. 8 illustrates an outer elevation view of frame of a reconfigurable vehicle customization system, in accordance with other embodiments.

FIG. 9 illustrates a front elevation view of frame of a reconfigurable vehicle customization system, in accordance with other embodiments.

FIG. 10 illustrates a flow diagram of an example method for using a reconfigurable vehicle customization system, according to various embodiments.

### DESCRIPTION OF EMBODIMENTS

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, and components have not been described in detail as not to unnecessarily obscure aspects of the described embodiments.

### Overview of Discussion

Embodiments described herein provide a reconfigurable vehicle customization system including a frame and at least one modular component. The frame includes a plurality of side members configured to be fixedly coupled to an interior of a motor vehicle using existing attachment points of the motor vehicle and without irreparable modification of the motor vehicle, where each side member of the plurality of side members includes at least one track for receiving a modular component. The at least one modular component is removably couplable to the at least one track of the plurality of side members.

In accordance with various embodiments, an interior compartment of a motor vehicle, e.g., a van, is modified to include a frame configured to receive removable modular components. The Mercedes-Benz Sprinter cargo van or passenger van with removable interior components is an example of such a van. The frame is fixedly installed within the interior compartment, e.g., behind the front seats of the van, using existing attachment points and with permanent modification of the motor vehicle. For example, in some embodiments, original equipment manufacturer (OEM) apertures are used as attachment points for fixedly attaching the frame to the motor vehicle. It should be appreciated that covers, caps, lids, or other coverings for concealing the existing attachment points can be removed without permanently modifying the interior compartment of the motor vehicle. By attaching the frame to the interior compartment of the motor vehicle without permanent modification of the motor vehicle, the condition of the motor vehicle can be preserved for purposes of maintaining resale value, or reuse upon removal of the frame, without damaging or impacting the condition and performance of the interior compartment.

The frame is configured to receive at least one modular component that is removably couplable to the frame. The at least one modular component provides some type of utility for users of the motor vehicle. As examples, and without limitation, the modular component can include a flat surface, a bed or mattress, fans, food storage and preparation, a cooler, entertainment components such as televisions, music players and speakers, a shower, etc.

In some embodiments, the modular components are coupled to the frame using quick release connectors. By using quick release connectors, the modules are fixed to the frame during operation, but are quickly removable and replaceable (e.g., hot-swappable) during configuration for particular users. For example, a motor vehicle including a frame as described herein may be available for rent by a rental company. The rental company may allow renters to selectively configure the desired utility of the motor vehicle they are renting, e.g., by selecting features they would like and/or by directly selecting the desired modular components. For instance, a family of four may desire bedding for four people and a kitchen and food storage module, while an individual renter may desire a single bed, a kitchen module, a shower module, and an entertainment module. Since the modules are coupled to the frame using quick release connectors, the module can be quickly replaced by the rental company during the transition period between renters, minimizing the time needed to customize the vehicle, thereby minimizing vehicle downtime.

Embodiments described herein provide a reconfigurable vehicle customization system including a frame and at least one modular component and a method for using such a reconfigurable vehicle configuration system. The described embodiments provide enhancements to the interior compartment of the motor vehicle by providing customizable utility options for users. Moreover, described embodiments improve the availability of customizable motor vehicles by providing for efficient and quick reconfiguration of the customization, allowing for rapid turnover with reduced labor and time expenditures.

### Example Reconfigurable Vehicle Customization System

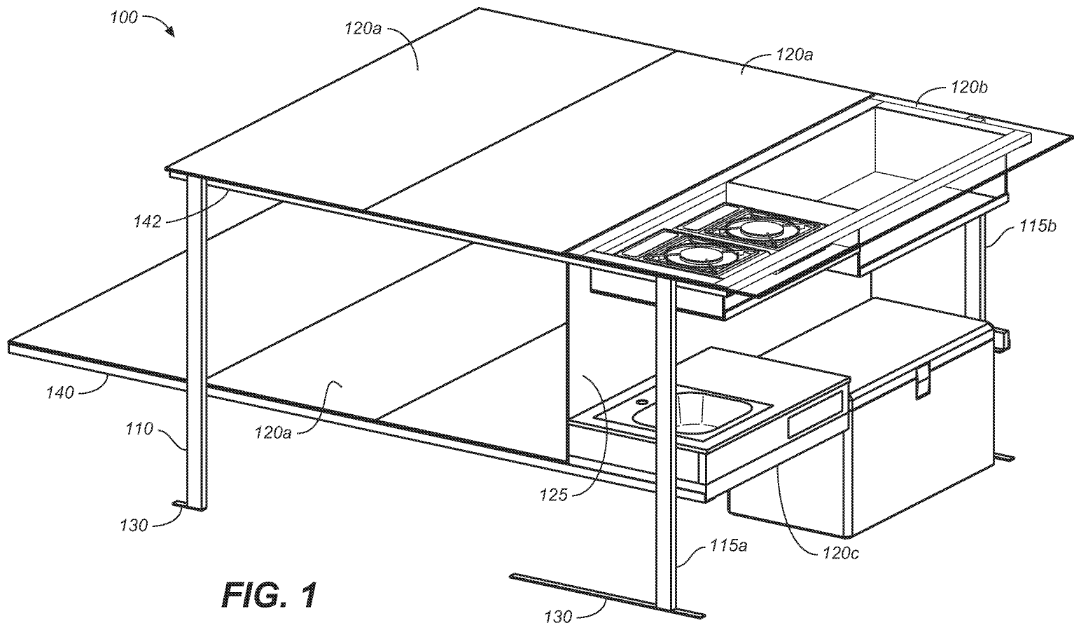

Turning now to the figures, FIG. 1 illustrates a perspective view of a reconfigurable vehicle customization system 100, in accordance with various embodiments. System 100 includes a frame 110 comprised of side members 115a and 115b. Side members 115a and 115b include attachment members 130 for fixedly coupling frame 110 to an interior of a motor vehicle. In some embodiments, frame 110 is fixedly coupled to the interior of a motor vehicle using existing attachment points of the motor vehicle and without irreparable modification of the motor vehicle. In some embodiments, the existing attachment points of the motor vehicle comprise original equipment manufacturer (OEM) apertures. It should be appreciated system 100 can be fixedly coupled to a floor of the motor vehicle and/or sidewalls of the motor vehicle.

Side members 115a and 115b include tracks 140 and 142 (illustrated on side member 115a) for receiving modular components. As illustrated, system 100 includes flat panel modules 120a, fan module 120b, and food preparation and storage module 120c, collectively referred to herein as modular components 120. Modular components 120 are removably coupled to tracks 140 and/or 142. In accordance with various embodiments, and without limitation, modular components 120 are removably coupled to tracks 140 and/or 142 using screws, bolts, push-pins, and other removable fasteners. In some embodiments, the modular components 120 can be coupled to and removed from tracks 140 and 142 without requiring the use of tools.

In accordance with various embodiments, modular components 120 are removably couplable to tracks 140 and/or 142 using quick release connectors. It should be appreciated that the quick release connectors can be separate components or integrated into either the modular components 120 or tracks 140 and 142. In some embodiment, tracks 140 and 142 includes aperture for receiving the quick release connectors. In some embodiments, modular components 120 include apertures for receiving the quick release connectors.

It should be appreciated that modular components 120 can provide varying and numerous types of functionality and utility and are not intended to be limited to the illustrated or described embodiments. In accordance with the illustrated embodiments, flat panel modules 120a provide a flat surface capable of supporting non-modular objects, such as mattresses, sleeping bags, cushions, luggage, boxes, etc. Food preparation and storage module 120c can include a sink, a cutting/food preparation surface, and a cooler (e.g., a kitchen unit), as illustrated, as well as other components such as a refrigerator, a cooking surface, an oven, a microwave oven, a barbeque, etc. Fan module 120b can include a fan(s), lighting, e.g., for providing illumination to food preparation and storage module 120c, shelving, storage, etc.

In some embodiments, system 100 includes components that can be removably coupled to both tracks 140 and 142. For example, as illustrated, system 100 includes vertical panel module 125 that is removably coupled to tracks 140 and 142. Vertical panel module 125, for instance, provides separation between food preparation and storage module 120c and the lower flat panel modules 120a removably coupled to track 140.

As illustrated, system 100 is fixedly coupled to the interior compartment of a motor vehicle such that fan module 120b and food preparation and storage module 120c are towards the rear of the motor vehicle, allowing access to fan module 120b and food preparation and storage module 120c upon opening the rear access door(s) of the motor vehicle. Where the motor vehicle is a van, for example, the rear entry to the van can include one or more doors, such as barn doors (vertical hinges on the side of the doors) or a tailgate door (horizontal hinges on the top of the door).

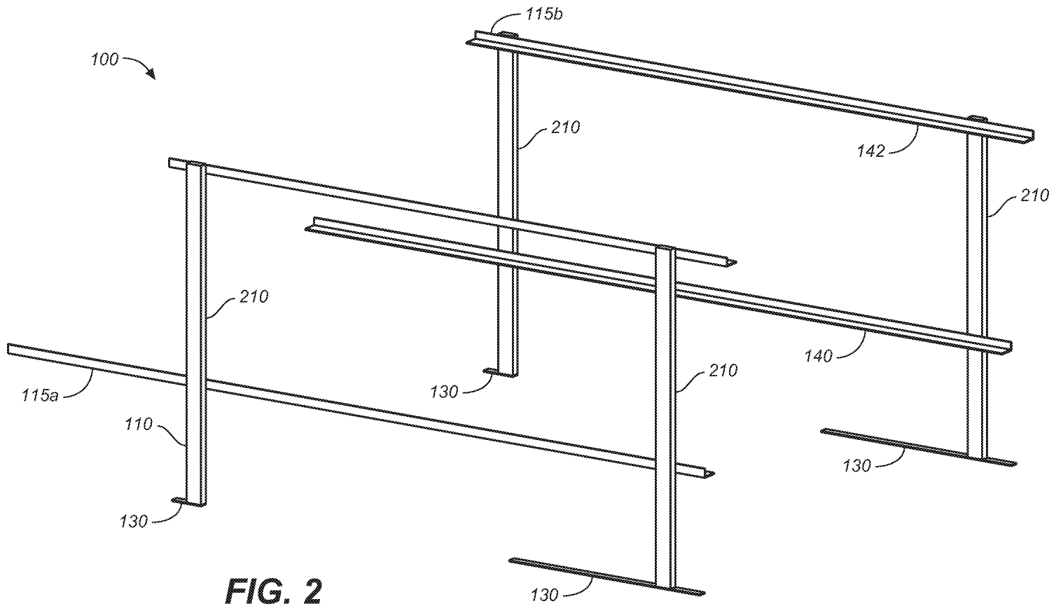

FIG. 2 illustrates a perspective view of frame 110 of a reconfigurable vehicle customization system 100, in accordance with various embodiments. Frame 110 includes side members 115a and 115b. Side members 115a and 115b include vertical members 210 connected to tracks 140 and 142. It should be appreciated that side members 115a and 115b can include any number of tracks and vertical members and is not intended to be limited to the illustrated embodiments. At least some vertical members 210 are connected to attachment members 130 for fixedly coupling frame 110 to an interior of a motor vehicle. It should be appreciated that frame 110 can also include cross members connected to side members 115a and 115b to provide additional structural support.

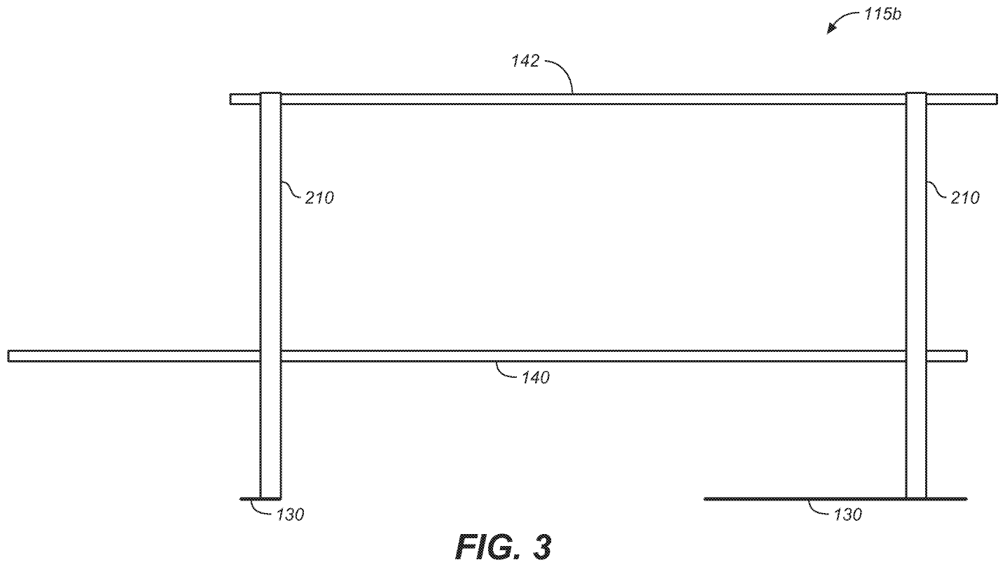

FIG. 3 illustrates an elevation view of side member 115b of a reconfigurable vehicle customization system 100, in accordance with various embodiments. Side member 115b includes vertical members 210 connected to tracks 140 and 142. It should be appreciated that side member 115b can include any number of tracks and vertical members and is not intended to be limited to the illustrated embodiments. At least some vertical members 210 are connected to attachment members 130 for fixedly coupling side member 115b to an interior of a motor vehicle. It should be appreciated that side member 115a is a mirror image of side member 115b, as illustrated in FIG. 2.

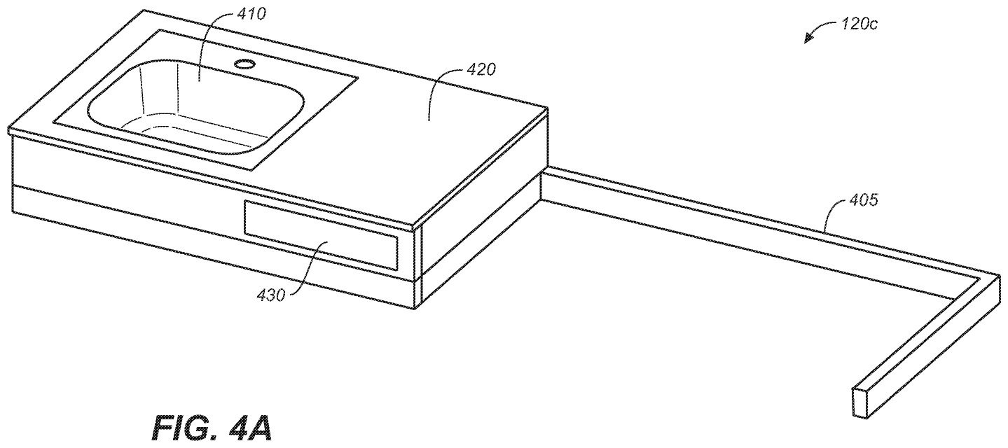

FIGS. 4A and 4B illustrate examples of a food preparation and storage module 120c, in accordance with various embodiments. As illustrated, food preparation and storage module 120c can includes support member 405, sink 410, cutting/food preparation surface 420, and drawer 430. Support member 405 is configured to receive additional components for additional functionality and utility. For instance, as illustrated in FIG. 4B, support member 405 receives cooler 440. It should be appreciated that food preparation and storage module 120c can include other components, e.g., at support member 405, such as a refrigerator, a cooking surface, an oven, a microwave oven, a barbeque, etc.

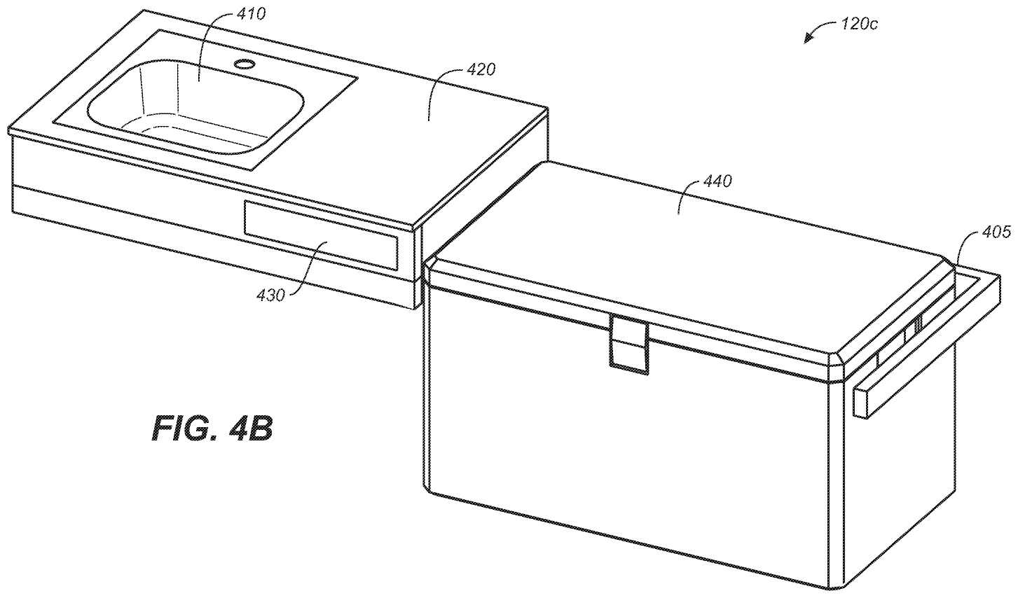

FIG. 5 illustrates an example of a fan module 120b, in accordance with various embodiments. Fan module 120b includes fans 510 and shelving 520. It should be appreciated that fan module 120b can include other components, such as lights for providing illumination to food preparation and storage module 120c, shelving, storage, etc.

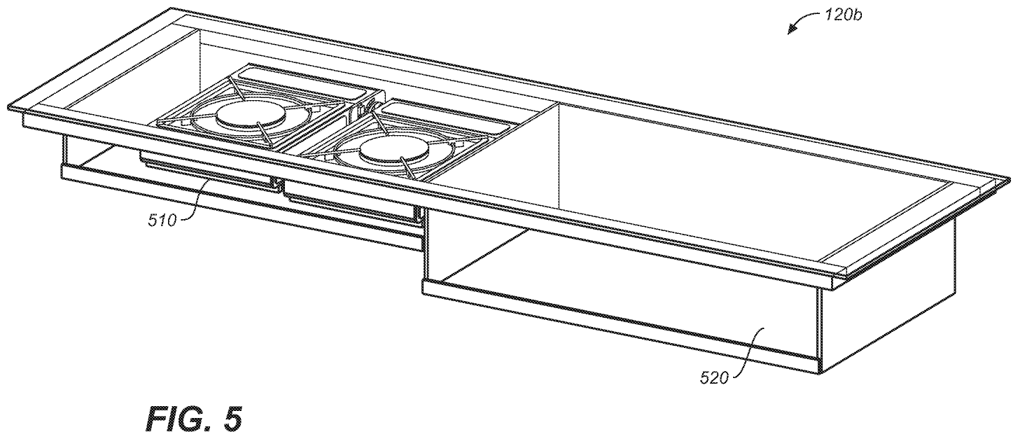

As illustrated in FIGS. 1-3, embodiments of a reconfigurable vehicle customization system include side members comprised of vertical members 210. It should be appreciated that the side members of a reconfigurable vehicle customization system can include panels in instead of or in addition to vertical members. FIG. 6 illustrates a perspective view of a frame 610 of a reconfigurable vehicle customization system 600, in accordance with other embodiments.

Frame 610 includes side panels 620a and 620b that include attachment members for fixedly coupling frame 610 to an interior of a motor vehicle. In some embodiments, frame 610 is fixedly coupled to the interior of a motor vehicle using existing attachment points of the motor vehicle and without irreparable modification of the motor vehicle. In some embodiments, the existing attachment points of the motor vehicle comprise original equipment manufacturer (OEM) apertures. It should be appreciated system 600 can be fixedly coupled to a floor of the motor vehicle and/or sidewalls of the motor vehicle. In some embodiments, frame 610 also includes cross members 630 connected to side panels 620a and 620b to provide additional structural support.

Side panels 620a and 620b include tracks for receiving modular components that are removably coupled to the tracks. In accordance with various embodiments, and without limitation, the modular components are removably coupled to tracks using screws, bolts, push-pins, and other removable fasteners. In some embodiments, the modular components can be coupled to and removed from the tracks without requiring the use of tools. In accordance with various embodiments, modular components are removably couplable to the tracks using quick release connectors. It should be appreciated that the quick release connectors can be separate components or integrated into either the modular components or the tracks. In some embodiment, the tracks include apertures for receiving the quick release connectors. In some embodiments, the modular components include apertures for receiving the quick release connectors.

It should be appreciated that the modular components can provide varying and numerous types of functionality and utility and are not intended to be limited to the illustrated or described embodiments. System 600 is configured to receive and include the same modular components as described in accordance with system 100 and can be removably coupled to flat panel modules 120a, fan module 120b, and food preparation and storage module 120c, collectively referred to herein as modular components 120, vertical panel module 125, or any other type of modular component.

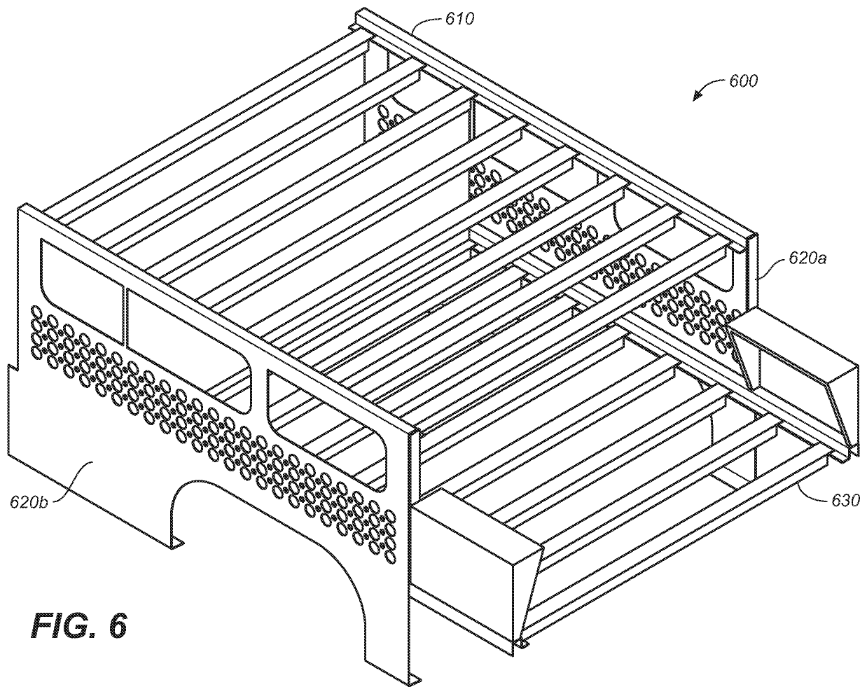

FIG. 7 illustrates a perspective inner view of side panel 620a of a reconfigurable vehicle customization system 600, in accordance with various embodiments. Side panel 620a includes tracks 710 and 712 for receiving modular components, and attachment members 720 for fixedly coupling frame 610 to an interior of a motor vehicle. Side panel 620a, and similarly side panel 620b, is comprised of a sheet of material, e.g., steel or another metal, and is fabricated to conform to the interior compartment of a motor vehicle. In some embodiments, side panels 620a is fabricated to conform to the interior compartment of a particular make and model of a motor vehicle. For instance, attachment members 720 are fabricated to align with attachment points of the motor vehicle. It should be appreciated that other features of side panels 620a (and 620b) can be fabricated to conform to and/or align with elements of the interior components of the motor vehicle, e.g. wheel well opening 730. It should be appreciated that side panel 620a is a mirror image of side panel 620b, as illustrated in FIG. 6.

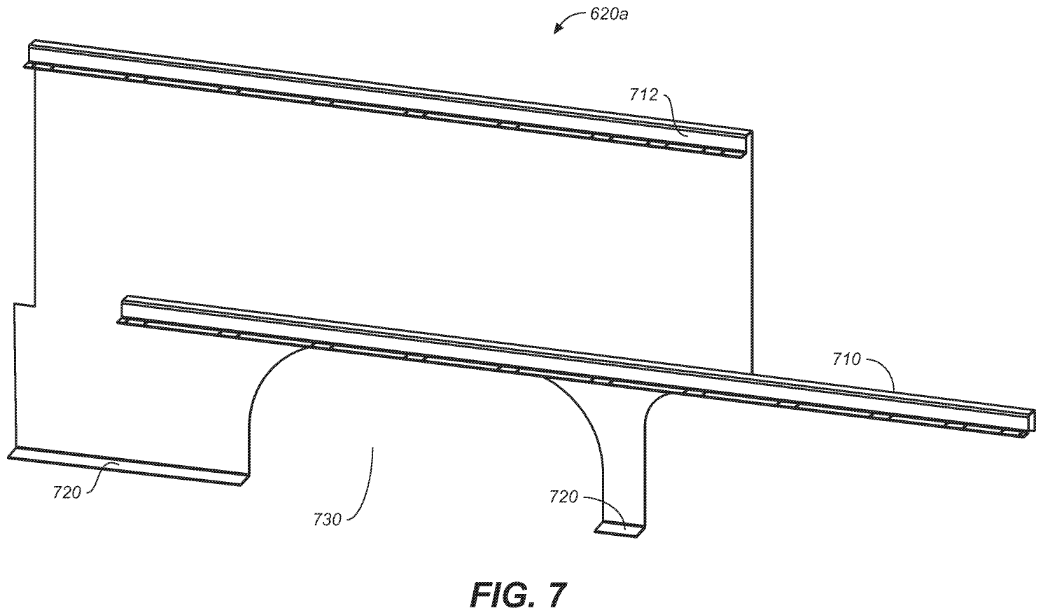

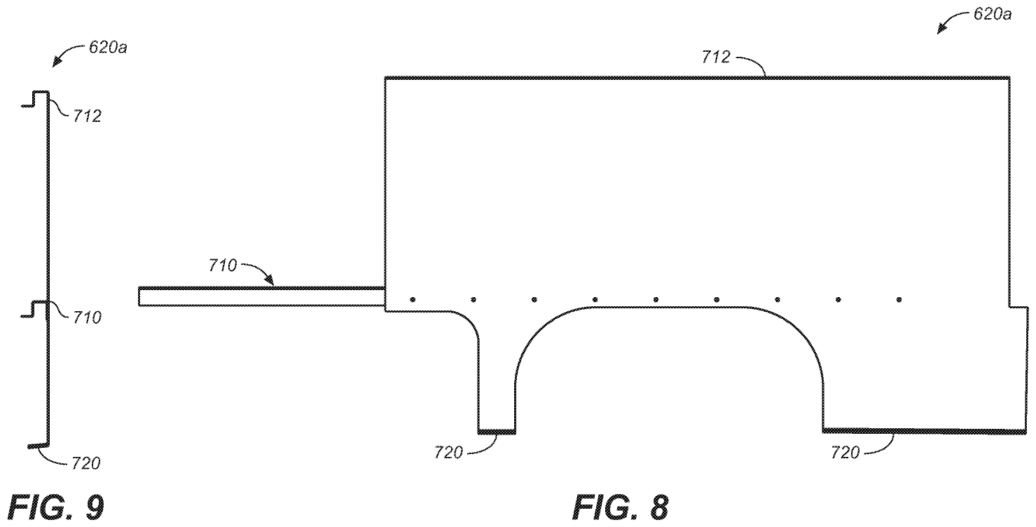

FIG. 8 illustrates an outer elevation view of side panel 620a of reconfigurable vehicle customization system 600, in accordance with other embodiments. As illustrated, side panel 620a includes track 710 and 712 and attachment members 720. In the illustrated embodiment, side panel 620a, track 712, and attachment members 720 are fabricated out of a single piece of material (e.g., metal) and track 710 is a separated component that is connected to side panel 620a, e.g., via welding, bolts, or rivets. FIG. 9 similarly illustrates a front elevation view of side panel 620a of reconfigurable vehicle customization system 600, in accordance with other embodiments.

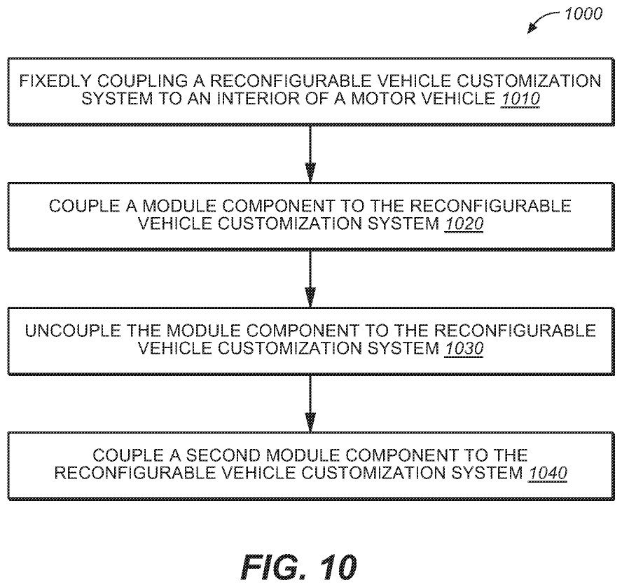

FIG. 10 illustrates a flow diagram 1000 of an example method for using a reconfigurable vehicle customization system, according to various embodiments. Procedures of this method may be described with reference to elements and/or components of various figures described herein. It is appreciated that in some embodiments, the procedures may be performed in a different order than described, that some of the described procedures may not be performed, and/or that one or more additional procedures to those described may be performed.

In one embodiment, as shown at procedure 1010 of flow diagram 1000, a reconfigurable vehicle customization system (e.g., reconfigurable vehicle customization system 100 or reconfigurable vehicle customization system 600) is fixedly coupled to an interior of a motor vehicle. In some embodiments, side members or side panels of the reconfigurable vehicle customization system are fixedly coupled to the interior of a motor vehicle using existing attachment points of the motor vehicle and without irreparable modification of the motor vehicle. In some embodiments, the side members or side panels include at least one track for receiving at least one modular component.

At procedure 1020, a modular component (e.g., a modular component 120) is coupled to the reconfigurable vehicle customization system.

In one embodiment, at procedure 1030, the modular component is uncoupled from the reconfigurable vehicle customization system.

At procedure 1040, a second modular component (e.g., a modular component 120) is coupled to the reconfigurable vehicle customization system.

### Conclusion

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. Many aspects of the different example embodiments that are described above can be combined into new embodiments. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A reconfigurable vehicle customization system comprising:
a frame comprising:
a plurality of side members configured to be fixedly coupled to an interior of a motor vehicle using existing attachment points of the motor vehicle and without irreparable modification of the motor vehicle, each side member of the plurality of side members comprising at least one track for receiving a modular component; and
at least one modular component that is removably couplable to the at least one track of the plurality of side members.

2. The reconfigurable vehicle customization system of claim 1, wherein the at least one modular component is removably couplable to the at least one track of the plurality of side members using quick release connectors.

3. The reconfigurable vehicle customization system of claim 2, wherein the at least one track of each side member comprises apertures for receiving the quick release connectors.

4. The reconfigurable vehicle customization system of claim 2, wherein the at least one modular component comprises apertures for receiving the quick release connectors.

5. The reconfigurable vehicle customization system of claim 2, wherein the at least one modular component comprises the quick release connectors.

6. The reconfigurable vehicle customization system of claim 1, wherein the existing attachment points of the motor vehicle comprise original equipment manufacturer (OEM) apertures.

7. The reconfigurable vehicle customization system of claim 1, wherein the plurality of side members is configured to be fixedly coupled to the interior of the motor vehicle at existing attachment points in a floor of the motor vehicle.

8. The reconfigurable vehicle customization system of claim 7, wherein the plurality of side members is further configured to be fixedly coupled to the interior of the motor vehicle at existing attachment points in sidewalls of the motor vehicle.

9. The reconfigurable vehicle customization system of claim 1, wherein the at least one modular component comprises a flat surface for supporting a mattress.

10. The reconfigurable vehicle customization system of claim 1, wherein the at least one modular component comprises a kitchen unit.

11. A motor vehicle comprising:
an interior compartment comprising existing attachment points;
a reconfigurable vehicle customization system comprising:
a plurality of side panels configured to be fixedly coupled to the interior compartment of the motor vehicle at the existing attachment points and without irreparable modification of the motor vehicle, each side panel of the plurality of side panels comprising at least one track for receiving a modular component, wherein the plurality of side panels is configured to be fixedly coupled to the interior compartment of the motor vehicle at existing attachment points in a floor of the motor vehicle; and
at least one modular component that is removably couplable to the at least one track of the plurality of side panels, wherein the at least one modular component is removably couplable to the at least one track of the plurality of side panels using quick release connectors.

12. The motor vehicle of claim 11, wherein the at least one track of each side panel comprises apertures for receiving the quick release connectors.

13. The motor vehicle of claim 11, wherein the at least one modular component comprises apertures for receiving the quick release connectors.

14. The motor vehicle of claim 11, wherein the at least one modular component comprises the quick release connectors.

15. The motor vehicle of claim 11, wherein the existing attachment points of the motor vehicle comprise original equipment manufacturer (OEM) apertures.

16. The motor vehicle of claim 11, wherein the plurality of side panels is further configured to be fixedly coupled to the interior compartment of the motor vehicle at existing attachment points in sidewalls of the motor vehicle.

17. The motor vehicle of claim 11, wherein the at least one modular component comprises a flat surface for supporting a mattress.

18. The motor vehicle of claim 11, wherein the at least one modular component comprises a kitchen unit.

19. A method for using a reconfigurable vehicle customization system, the method comprising:
fixedly coupling a plurality of side members to an interior of a motor vehicle using existing attachment points of the motor vehicle and without irreparable modification of the motor vehicle, each side member of the plurality of side members comprising at least one track for receiving at least one modular component; and
coupling a modular component to the at least one track of the plurality of side members.

20. The method of claim 19, further comprising:
uncoupling the modular component to the at least one track of the plurality of side members; and
coupling a second modular component to the at least one track of the plurality of side members.
